(19) United States
(12) Patent Application Publication
(10) Pub. No.: US 2002/0053264 A1
(43) Pub. Date: May 9, 2002

(54) NUMERICALLY CONTROLLED MACHINE TOOL

(76) Inventors: KOICHI KIKUCHI, NUMAZU-SHI (JP); TAKAHIRO FUNAKI, NUMAZU-SHI (JP)

Correspondence Address: PILSBURY WINTHROP LLP, INTELLECTUAL PROPERTY GROUP, 1600 TYSONS BOULEVARD, McLEAN, VA, 22102, US

(21) Appl. No.: 09/347,197

(22) Filed: Jul. 2, 1999

(30) Foreign Application Priority Data
Jul. 2, 1998 (JP) 187518/1998

(51) Int. Cl. B23B 1/00; B23B 41/06

(52) U.S. Cl. 82/1.4; 82/118

(57) ABSTRACT

A numerically controlled machine tool comprises a work holding unit for holding a workpiece, and a tool capable of being moved along the Z-axis into a central bore formed in the workpiece. The tool has a shank and a cutting chip attached to the shank so as to project laterally from the shank. A driving mechanism controlled by a control unit moves the tool along a substantially circular path in an X-Y plane so that the cutting chip moves in a direction substantially coinciding with a tangent to the internal surface of the central bore of the workpiece at the point of contact of the cutting chip with the internal surface of the central bore.

### BACKGROUND OF THE INVENTION

1. Field of the Invention

The present invention relates to a numerically controlled machine tool (hereinafter referred to as “NC machine tool”) and, more particularly, to a NC machine tool included in a machining center capable of making use of three axes, i.e., an X-axis, a Y-axis and a Z-axis, and capable of exercising functions of tools respectively having different diameters by carrying out operations along the X-axis and the Y-axis.

2. Description of the Related Art

When forming a bore in a workpiece on a machining center by a conventional boring method, the workpiece is disposed with the axis of the bore to be formed therein aligned with the axis of a rotating-end tool of a diameter corresponding to that of the bore, the rotating-end tool is rotated, and then the workpiece is moved in the direction of the depth of the bore relative to the rotating rotating-end tool. This boring methods needs rotating-end tools respectively having different diameters for forming bores of different diameters, respectively.

If the machining center is required to form bores of many different diameters, many rotating-end tools of diameters corresponding to those of the bores to be formed must be kept in reserve, which requires a large tool cost. When forming many bores of different diameters in a workpiece, frequent tool changing operation spends much time, extending total machining time necessary for machining the workpiece.

### SUMMARY OF THE INVENTION

The present invention has been made in view of the foregoing problems in the prior art and it is therefore an object of the present invention to provide a NC machine tool capable of boring a plurality of bores of different diameters with a single rotating-end tool, of reducing tool cost and of curtailing tool changing time.

According to one aspect of the present invention, a NC machine tool comprises: a work holding unit for holding a workpiece; a tool having a shank to be attached to a spindle, and a cutting chip attached to the shank so as to project laterally from the shank and capable of being inserted in a central bore formed in the workpiece; a driving mechanism for driving at least either the shank of the tool or the work holding unit for movement along a substantially circular path; and a control unit for controlling the driving mechanism, in which the control unit controls the driving mechanism so that the cutting chip in contact with the internal surface of the central bore of the workpiece moves in a direction substantially coinciding with a tangent touching the internal surface of the central bore at the point of contact of the cutting chip with the internal surface of the central bore.

The shank of the tool or the work holding unit is moved along a substantially circular path so that the moving direction of the cutting chip coincides with a tangent touching the internal surface of the central bore at the point of contact of the cutting chip with the internal surface of the central bore, whereby the central bore of the workpiece can be enlarged in a desired diameter.

### BRIEF DESCRIPTION OF THE DRAWINGS

The above and other objects, features and advantages of the present invention will become more apparent from the following description taken in connection with the accompanying drawings, in which:

FIG. 1 is a diagrammatic view of a NC machine tool in a preferred embodiment according to the present invention;

FIG. 2 is a block diagram of a control unit included in the NC machine tool shown in FIG. 1;

FIGS. 3A and 3B are diagrammatic views of assistance in explaining the operation of the NC machine tool shown in FIG. 1;

FIG. 4 is a flow chart of a control procedure to be carried out by the NC machine tool shown in FIG. 1; and

FIG. 5 is a view of a part of a control program to be carried out by the NC machine tool shown in FIG. 1.

### DESCRIPTION OF THE PREFERRED EMBODIMENTS

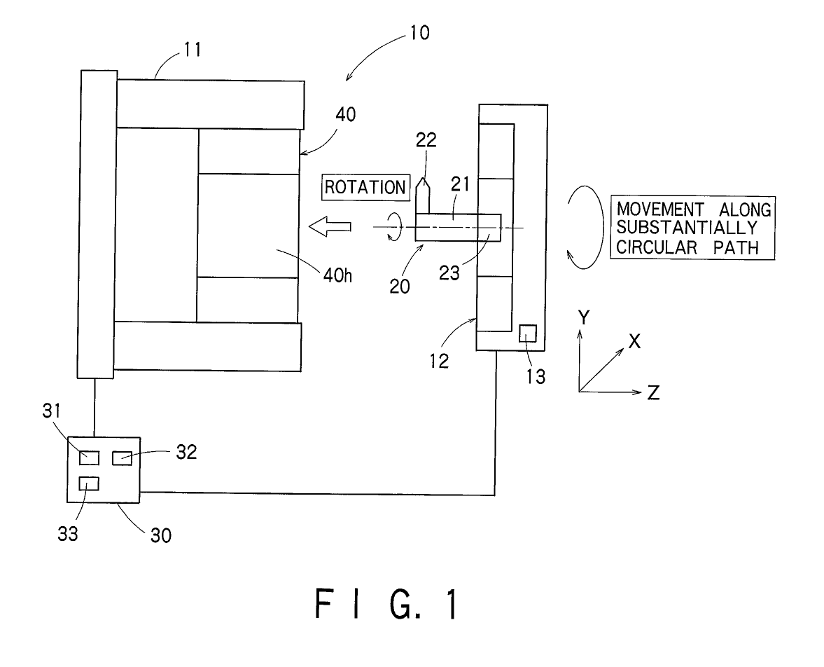

Referring to FIG. 1, a NC machine tool 10 in a preferred embodiment according to the present invention comprises a work holding unit 11 for holding a workpiece 40 provided with a central bore 40h, a tool 20 to be moved along a Z-axis into the central bore 40h of the workpiece 40, a driving mechanism 12 for translating the tool 20 in an X-Y plane defined by an X-axis and a Y-axis, and a control unit 30 for controlling the driving mechanism 12.

The tool 20 has a shank 21 to be attached to a spindle, and a cutting chip 22 attached to the shank 21 so as to project laterally from the shank 21. The spindle holding the shank 21 is driven for rotation by a spindle motor 23. The driving mechanism 12 is provided with a feed motor 13 for driving the tool 20 for movement along a substantially circular path in the X-Y plane.

The control unit 30 comprises a program storage unit 31 storing a control program, an input unit 32 for inputting control instructions, and a program executing unit 33 for executing the control program stored in the program storage unit 31 according to control instructions given thereto by the input unit 32.

The control program is stored beforehand in the program storage unit 31. The control program has instructions including a mode instruction specifying a control mode, a speed instruction specifying a moving speed for movement along a circular path and a machining instruction. The program executing unit 33 executes operations for changing control modes, determining the rotating speed S (rpm) of the shank 21.

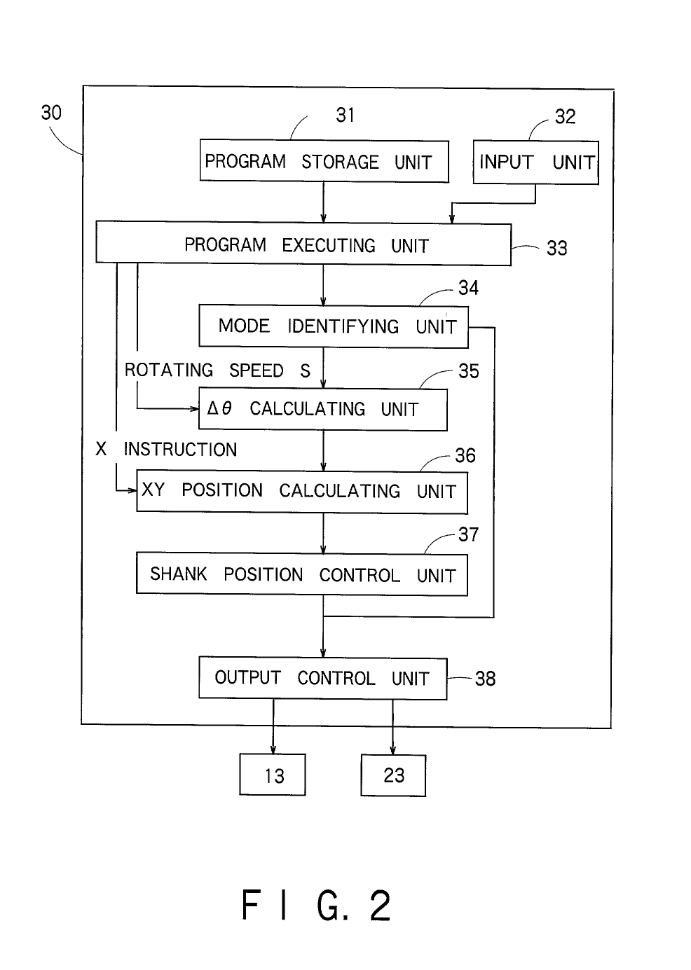

As shown in FIG. 2, a mode identifying unit 34, a Δθ calculating unit 35 and an XY position calculating unit 36 are connected to the program executing unit 33. The mode identifying unit 34 is connected to the Δθ calculating unit 35, the Δθ calculating unit 35 is connected to the XY position calculating unit 36, the XY position calculating unit 36 is connected to a shank position control unit 37, and the shank position control unit 37 and the mode identifying unit 34 are connected to an output control unit 38.

When the mode identifying unit 34 identifies that a revolving mode is selected as a control mode, the Δθ calculating unit 35 calculates an angle Δθ (°) of revolution per unit time (a revolving angular velocity), on the basis of the rotating speed S of the shank 21.

The XY position calculating unit 36 calculates radius r of revolution at each of positions on the Z-axis of the tool 20 on the basis of instructions which are included in the control program and which specify Z-positions and X-positions, and calculates the X- and the Y-position of the tool 20 using the angle Δθ of revolving by using the following expressions.

X=r×cos (θ)

Y=r×sin (θ)

The shank position control unit 37 controls the position of the shank 21 in the X-Y plane at time points on the basis of the angle Δθ of revolution.

The output control unit 38 controls the feed motor 13 of the driving mechanism 12 on the basis of the data specifying the X- and the Y-position. The output control unit 38 also controls the spindle motor 23 for driving the shank 21 of the tool 20 for rotation on the basis of the position of the shank 21 in the X-Y plane. Thus, the movement of the tool 20 is controlled so that the moving direction of the cutting chip 22 of the tool 20 at the point of contact of the cutting chip 22 with the internal surface 40p of the central bore 40h of the workpiece 40 coincides always with a tangent to the internal surface 40p at the point of contact of the cutting chip 22 with the internal surface 40p.

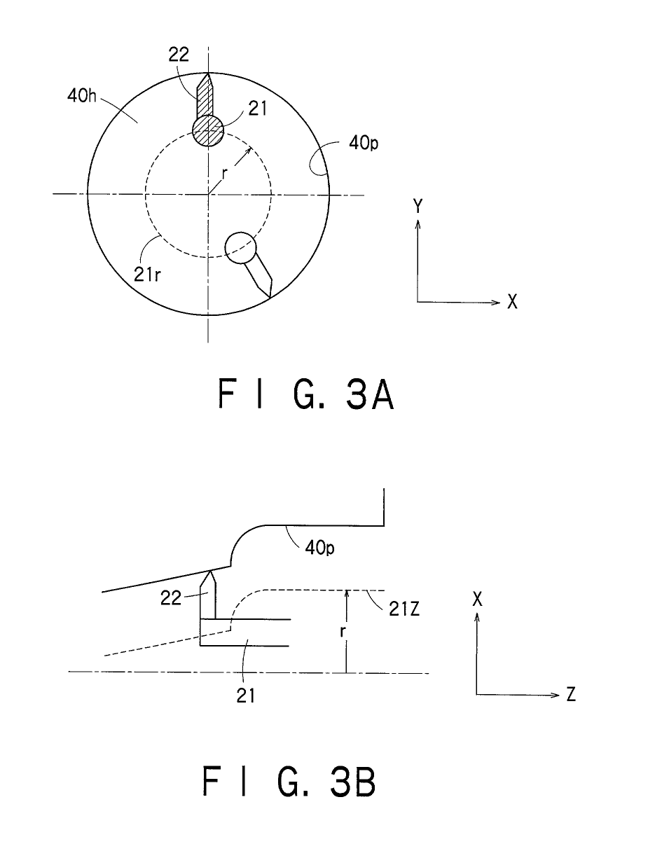

The operation of the NC machine tool will be described with reference to FIGS. 3A and 3B. FIGS. 3A and 3B show a path 21r of the shank 21 of the tool 20 in an X-Y plane and a path 21z of the same in an X-Z plane, respectively.

The workpiece 40 provided with the central bore 40h is attached to the work holding unit 11. The diameter of the central bore 40h is smaller than that of a bore to be formed by machining in the workpiece 40, but must be greater than the distance between the tip of the cutting chip 22 and the center axis of the shank 21.

The control unit 30 controls the driving mechanism 12 to position the shank 21 at an initial shank position with its center axis 21 aligned with the center axis of the central bore 40h of the workpiece 40. The initial position of the shank 21 is used as a reference program point in control steps.

A polar coordinate system is set in an X-Y plane perpendicular to the axis of the shank 21 on the basis of the initial cutting position of the cutting tool 22 (orientation). For example, the position of the shaded shank 21 shown in FIG. 3A is referred to as “angular position 90°”.

When a mode instruction selecting a revolving mode is given to the input unit 15, an X-Y coordinate system of the cutting chip 22 wherein the program point is the origin 0, and the polar coordinate system of the cutting chip 22 are established. A Z-r coordinate system similar to that for a lathe operation is established for the central hole 40h of the workpiece 40. In the Z-r coordinate system, the position of the center axis of the central bore 40h is represented by a coordinate r=0 and a coordinate Z on the Z-axis.

Subsequently, the program executing unit 33 executes the control program and provides instructions similar to those given to a lathe operation, i.e., instructions specifying a radius r and a depth Z in the Z-r coordinate system defining a shape to be formed by machining. For example, a shape as shown in FIG. 3B is specified. The Z-r coordinate system is the same as the conventional Z-X coordinate system.

Machining parameters including the rotating speed S of the shank 21, the rotating direction of the shank 21 and a time point when the shank 21 is to start moving are controlled according to the control program. Consequently, the shank 21 starts rotating, the rotating shank 21 of the tool 20 is moved along the circular path 21r and the cutting chip 22 is brought into engagement with the internal surface 40p of the central bore 40h of the workpiece 40 to start a machining operation.

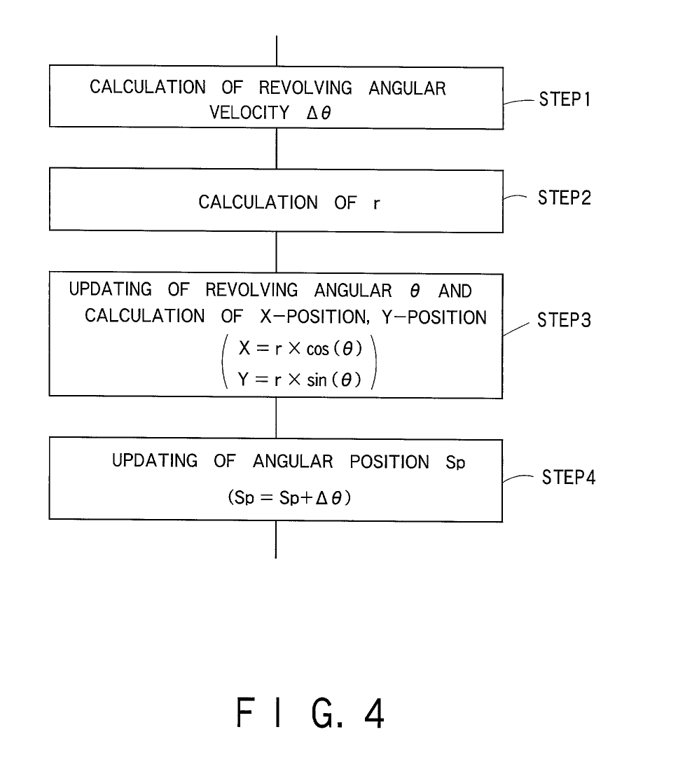

After the machining operation has been started, the control unit 30 (FIG. 2) executes a control procedure shown in FIG. 4.

First, the Δθ calculating unit 35 calculates an angle Δθ (°) of revolution per unit time (ms), on the basis of the rotating speed S (rpm), when the mode identifying unit 34 identifies that an orbit mode is selected (STEP 1).

The control program specifies a desired revolving angular velocity Δθ, (°) per unit time t(ms), which is expressed by:

Δθ=(S/60)×360×(t/1000)

Usually, the override of the spindle is taken into consideration in determining the desired revolving angular velocity Δθ. The revolving angular velocity Δθ is adjusted by acceleration and deceleration to the desired revolving angular velocity Δθ. An acceleration parameter Aₙ is specified in the control program. An example of the acceleration parameter Aₙ is expressed by:

Aₙ=Fₙ/(Tₙ/t)=t×Fₙ/Tₙ

wherein Fₙ is a maximum revolving angular velocity and Tₙ is a suitable parameter (ms).

The XY position calculating unit 36 calculates a radius r of a circular path for the shank 21 of the tool 20 on the basis of a Z-position and an r-instruction specified in the control program (STEP 2). The distribution of the Z-position and the r-instruction is achieved by a control method similar to a conventional control method and, usually, override F (%) is taken into consideration.

Then, the XY position calculating unit 36 calculates the X- and the Y-position of the tool 20 by using the revolution angle Δθ, and the angle θ is updated to θ+Δθ. An X-position and a Y-position is calculated (STEP 3) by using:

X=r×cos (θ)

Y=r×sin (θ)

The output control unit 38 controls the feed motor 13 of the driving mechanism 12 on the basis of the X- and the Y-position. The differences between the X-position determined in the preceding control cycle and that determined in the present control cycle and between the Y-position determined in the preceding control cycle and the Y-position determined in the present control cycle are distributions.

The shank position control unit 37 updates the angular position Sp of the shank 21 to Sp+Δθ (STEP 4). Thus, the driving mechanism 12 is controlled so that the cutting chip 22 of the tool 20 moves in a direction substantially coinciding with a tangent to the internal surface 40p of the central bore 40h at the point of contact of the cutting chip 22 with the internal surface 40p.

Thus, the control unit 30 controls the driving mechanism 12 so that the shank of the tool 20 moves along a substantially circular path 21r in the X-Y plane relative to the workpiece 40 as shown in FIG. 3A, and the cutting chip 22 of the tool 20 moves in a direction coinciding with a tangent to the internal surface 40p of the central bore 40h at the point of contact of the cutting chip 22 with the internal surface 40p. Consequently, the cutting chip 22 continues the machine operation, while being maintained in a relationship substantially perpendicular to the internal surface 40p of the central bore 40h of the workpiece 40.

The diameter of the internal surface 40p of the workpiece 40 increases with the progress of the machining operation. The cutting chip 22 is moved in the tangential direction of each internal surface according to the variation of the diameter of the central bore 40h during the machining operation; that is, the path 21r of the shank 21 of the tool 20 is a substantially circular path of a diameter gradually increasing according to the depth of cut by the cutting chip 22 to the workpiece 40. The diameter of the substantially circular path may be increased in either a stepwise mode or a continuous mode. If the diameter of the substantially circular path is increased in a stepwise mode, the path of the shank 21 of the tool 20 consists of circular paths and paths increasing (transferring) the diameter of the path in the stepwise mode. If the diameter of the substantially circular path is increased continuously, the path of the shank 21 of the tool 20 forms an involute.

The tool 20 is moved also in the direction of the Z-axis so that the shank 21 moves along the path 21z shown in FIG. 3B. Consequently, the NC machine tool in this embodiment achieves a thee-axis machining operation. The combined machining operation for machining in the X-Y plane and along the Z-axis may be controlled by any optional control method based on a conventional control method of controlling a combined machining operation for machining in the X-Y plane and along the Z-axis.

Generally, the shank 21 of the tool 20 rotates at a fixed rotating speed S. However, it is preferable to control the rotating speed S of the shank 21 so that a feed of the cutting chip 22 relative to the internal surface 40p of the workpiece 40 is substantially constant. The rotating speed of the shank 21 can be controlled through the control of the spindle motor 23 by the shank position control unit 37 and the output control unit 38.

As obvious from the foregoing description, the NC machine tool moves the shank 21 of the tool 20 along the substantially circular path so that the cutting tool 22 is moved always in a direction coinciding with a tangent to the internal surface 40p of the central bore 40h of the workpiece 40 at the point of contact of the cutting chip 22 with the internal surface 40p. Thus, the central bore 40h of the workpiece 40 can be finished in a desired diameter.

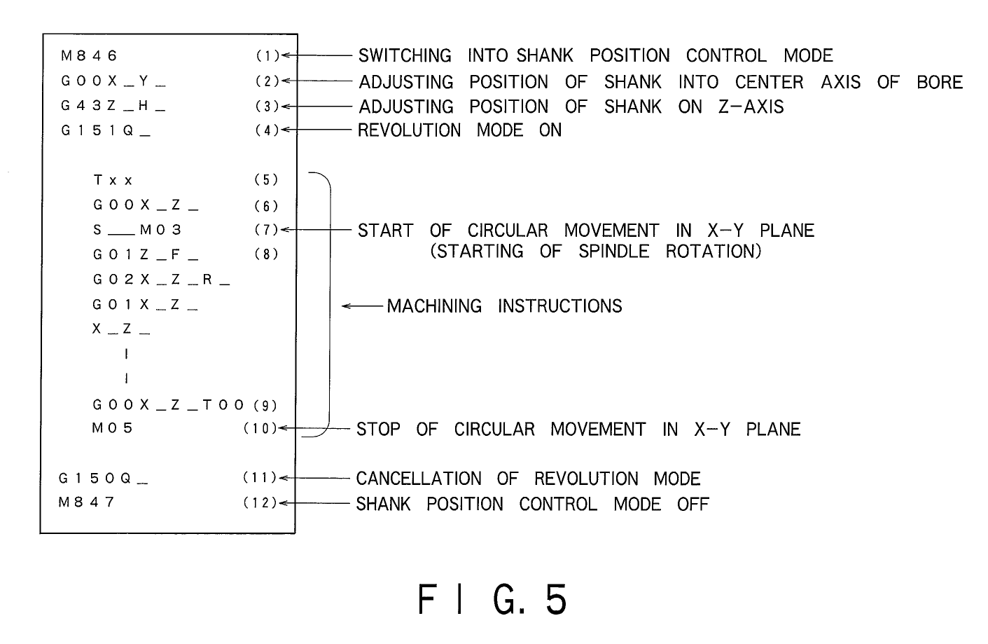

FIG. 5 shows an example of the control program. The operation of the control program will briefly be described.

A shank position control mode M846 is selected in command (1). The X- and the Y-position of the center axis of the shank are adjusted to those of the center axis of the bore in command (2). The position of the shank on the Z-axis is determined in command (3).

A revolution mode G151 is selected in command (4). In this state, shank angle, i.e., an angle between the direction of the tool and the positive direction of the X-axis, is specified by a Q instruction. A CNC system initializes the shank angle. If any Q instruction is not given, the shank angle is 0. An X-Y coordinate system is automatically set so that the origin thereof coincide with the present coordinates (X, Y), and a G18 (Z-X) plane is selected.

Machining instructions are started in command (5). A tool position offset Txx similar to the one in the lathe system is specified in command (5).

A rotating speed is specified by an S instruction and a rotating direction is specified by M03 (G02) or M04 (G03) in command (7). Operations for controlling a circular motion in the X-Y plane and a position of the shank are started in command (7).

An operation for moving the tool for machining is started in command (8). The position (value) of r is determined on the basis of instructions specifying a Z- and an x-position. An X-and a Y-position are determined from the r and the shank angle.

The tool position offset is cancelled in command (9).

Revolution of the tool along a circular path in the XY plane and the rotation of the shank are stopped by M05 in command (10). If a Q instruction is given, the shank is stopped at the angular position. If any Q instruction is not given, the shank is stopped at a position for starting G151.

The revolving mode is cancelled by G150 in command 11. G150 restores automatically the coordinate system set by G151, and selects a G17(X-Y) plane.

The shank position control mode is cancelled by M847 in command (12).

The control program may include other instructions including those specifying feed per rotation, tool position offset, edge roundness correction, composite cutting cycle and simplex cutting cycle.

Although the cutting chip 22 projects outward from the shank 21 in the embodiment described above, the shank 21 may have the shape of a hollow cylinder, and the cutting chip 22 may be attached to the shank 21 so as to project inward from the shank 21 to cut the external surface of the workpiece in a desired outside diameter.

Although the NC machine tool embodying the present invention has been described on an assumption that the tool 20 is moved along a substantially circular path relative to the work holding unit 11, the work holding unit 11 may be moved along a substantially circular path relative to the tool 20.

As apparent from the foregoing description, according to the present invention, the central bore of the workpiece can be enlarged in a desired diameter by moving the shank of the tool or the work holding unit along a substantially circular path so that the cutting chip moves in a direction coinciding with a tangent to the internal surface of the central bore of the workpiece at the point of contact of the cutting chip with the internal surface of the central bore.

Accordingly, bores of a plurality of different diameters can be formed by a single tool, so that tool cost can be reduced and time necessary for changing tool can be curtailed. The external surface of a workpiece can be machined in a desired diameter by employing a hollow, cylindrical shank and attaching a cutting chip to the hollow, cylindrical shank so as to project inward.

Although the invention has been described in its preferred embodiment with a certain degree of particularity, obviously many changes and variations are possible therein. It is therefore to be understood that the present invention may be practiced otherwise than as specifically described herein without departing from the scope and spirit thereof.

What is claimed is:

1. A numerically controlled machine tool comprising:
a work holding unit for holding a workpiece;
a tool having a shank to be attached to a spindle, and a cutting chip attached to the shank so as to project laterally from the shank and capable of being inserted in a central bore formed in the workpiece;
a driving mechanism for driving at least either the shank of the tool or the work holding unit for movement along a substantially circular path; and
a control unit for controlling the driving mechanism;
wherein the control unit controls the driving mechanism so that the cutting chip in contact with the internal surface of the central bore of the workpiece moves in a direction substantially coinciding with a tangent touching the internal surface of the central bore at the point of contact of the cutting chip with the internal surface of the central bore.

2. The numerically controlled machine tool according to claim 1, wherein the control unit comprises a program storage unit storing a control program, an input unit for inputting control instructions, and a program executing unit for executing the control program stored in the program storage unit on the basis of a control instruction provided by the input unit.

3. The numerically controlled machine tool according to claim 1, wherein the shank of the tool rotates at a fixed angular velocity.

4. The numerically controlled machine tool according to claim 1, wherein the shank of the tool rotates at such a speed that a feed of the cutting chip relative to the workpiece is substantially constant.

5. The numerically controlled machine tool according to claim 2, wherein the shank of the tool rotates at a fixed angular velocity.

6. The numerically controlled machine tool according to claim 2, wherein the shank of the tool rotates at such a speed that a feed of the cutting chip relative to the workpiece is substantially constant.
